(19) United States
(12) Patent Application Publication
(10) Pub. No.: US 2005/0266210 A1
(43) Pub. Date: Dec. 1, 2005

(54) Imprinted wood-plastic composite, apparatus for manufacturing same, and related method of manufacture

(76) Inventors: Blair Dolinar, Winchester, VA (US); Robert Thibodeau, Winchester, VA (US); Greg Ratlief, Winchester, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/856,811

(22) Filed: Jun. 1, 2004

(51) Int. Cl. B32B 9/00

(52) U.S. Cl. 428/172; 428/173

(57) ABSTRACT

The present invention is a composite that is imprinted. The composite may be made from an imprinting method which includes providing a wood-plastic composite having a surface, creating a plurality of depressions on surface of wood-plastic composite, and depositing a colorant in the plurality of depressions.

### FIELD OF THE INVENTION

The invention relates to apparatuses and methods for printing on composite boards, and composite boards. The printing may be accomplished by placing a colorant below the surface of the composite board using a printing apparatus having colorant on raised portions of the printing apparatus.

### BACKGROUND OF THE INVENTION

The color of wood-plastic composite boards are determined by a variety of factors. Among them are the types of materials used to make wood-plastic composite boards and the process by which wood-plastic composite boards are manufactured. Even with control of the materials used to make wood-plastic composite boards and the process by which wood-plastic composite boards are made, the resultant color of wood-plastic composite board that can be achieved is limited. In particular, it is difficult to control color variation across different portions of the surface of the board with any degree of accuracy. For example, the present inventors have found that it is difficult, if not impossible, to accurately and reliably place text or any geometric shape on the surface of wood-plastic composite simply by controlling the types of materials used to make wood-plastic composite boards and the process by which wood-plastic composite boards are made.

One method for accurately controlling color variation across different portions of surface of the board is to precisely deposit a pigment directly onto the substantially flat surface of the board in the desired configuration. However, due to the composition and geometry of the board, the pigment does not readily permeate into the substantially flat surface of the board, and thus the pigment tends to wear off. Thus, there remains a need from a composite board that can be effectively imprinted or colored in production.

### SUMMARY OF THE INVENTION

An embodiment of the invention includes an apparatus. The apparatus includes a printer including one or more protrusions, an applicator configured to apply a colorant to one or more of the one or more protrusions, and a presser configured to press a wood-plastic composite against the printer such that the one or more protrusions form one or more depressions in the wood-plastic composite and deposits the colorant in at least one of the one or more depressions.

In various embodiments, the invention may include one or more of the following aspects: the printer may be at least one of a cylinder, a roll, and a plate; the one or more protrusions may form a pattern; the applicator may be configured to apply the colorant to a first of the one or more protrusions and apply another colorant different from the colorant to a second of the one or more protrusions; the applicator may be configured to apply the colorant to a first of the one or more protrusions and not apply the colorant to a second of the one or more protrusions; the colorant may comprise a plurality of colorants; the presser may be at least one of a cylinder, a roll, and a plate; the printer and the presser may define a gap configured to accommodate the wood-plastic composite; the wood-plastic composite may further comprise a surface and the colorant may be applied to the wood-plastic composite below the surface; the wood-plastic composite may further comprise a surface and the colorant may be applied to the wood-plastic composite below the surface; the presser and the printer may be configured to form the one or more depressions on the wood-plastic composite and deposit at least some of the colorant in the one or more depressions substantially simultaneously; the protrusions may include at least one a groove and a textured surface.

Another embodiment of the invention includes a composite. The composite includes a plastic, a plurality wood fibers intermixed with the plastic, a surface comprising a plurality of depressions formed therein, and a colorant disposed in one or more of the plurality of depressions.

In various embodiments, the invention may include one or more of the following aspects: the plastic may be at least one of polypropylene and polyethylene and the wood fiber may be at least one of a hardwood and a softwood; the colorant may be disposed below the surface; the plurality of depressions may be disposed below the surface; another colorant different from the colorant; the colorant may be disposed in one or more of the plurality of depressions and the another colorant may be disposed in one or more of the plurality of depressions; the colorant may be disposed in a first portion of one of the plurality of depressions and may not be disposed in a second portion of the one of the plurality of depressions different from the first portion; the colorant may be a plurality of colorants; the composite may be at least one of a board, a decking board, and a decking component; the colorant may be disposed in at least a portion of the surface defining the plurality of depressions; the composite may be configured to impede removal of the colorant from the plurality of depressions; the surface may appear to be a same color as the colorant; the surface may appear to be a color different from a base color of the composite.

A further embodiment of the invention includes a method. The method includes providing a wood-plastic composite having a surface, creating a plurality of depressions on surface of wood-plastic composite, and depositing a colorant in the plurality of depressions.

In various embodiments, the invention may include one or more of the following aspects: providing the wood-plastic composite may includes providing at least one of a wood-plastic board, a wood-plastic decking board, and a wood-plastic decking component; creating the plurality of depressions may include creating the plurality of depressions using a plurality of protrusions; creating the plurality of depressions may include creating the plurality of depressions such that the plurality of depressions are disposed below the surface; depositing the colorant may include depositing the colorant in a first subset of the plurality of depressions; depositing another colorant in a second subset of the plurality of depressions different from the first subset; depositing the colorant may include depositing the colorant in a first subset of the plurality of depressions and not depositing the colorant in a second subset of the plurality of depressions different from the subset of the plurality of depressions; depositing the colorant in at least a portion of the surface defining the plurality of depressions; feeding the wood-plastic composite between a plurality of cylinders; one of the plurality of cylinders may be configured to create the plurality of depressions; the plurality of protrusions may have at least one of a groove and a textured surface.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are illustrative and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic view of an apparatus and a composite according to an embodiment of the present invention;

FIG. 2 is a schematic view of a printer of the apparatus of FIG. 1;

FIG. 3 is a schematic view of the composite of FIG. 1;

FIG. 4 is a cross-sectional view of the composite along line IV-IV of FIG. 3;

FIG. 5 is a cross-sectional view of the printer along line V-V of FIG. 2;

FIG. 6 is a cross-sectional view of a protrusion of a printer according to another embodiment of the present invention;

FIG. 6A is a cross-sectional view of a protrusion of a printer according to still another embodiment of the present invention;

FIG. 6 is a cross-sectional view of a protrusion of a printer according to a still further embodiment of the present invention;

FIG. 7 is a cross-sectional view of a depression of a composite according to a further embodiment of the present invention;

FIG. 8 is a cross-sectional view of a printer according to yet another embodiment of the present invention; and

FIG. 9 is a cross-sectional view of a printer according to a yet further embodiment of the present invention.

### DESCRIPTION OF THE EMBODIMENTS

Reference will now be made in detail to a preferred embodiment of the invention, an example of which are illustrated in the accompanying drawings. Wherever possible, the same reference numbers will be used throughout the drawings to refer to the same or like parts.

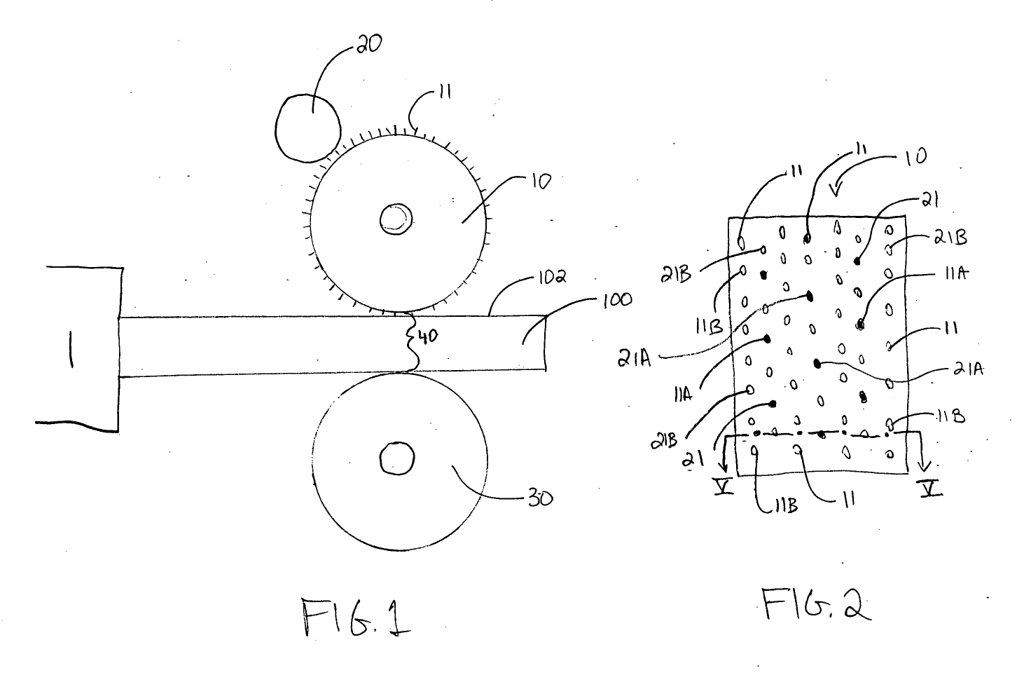

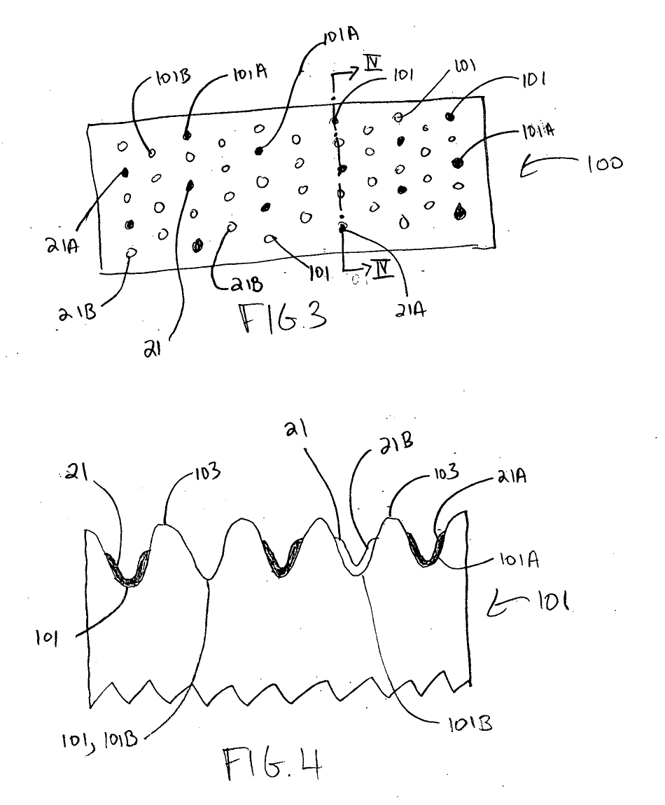

FIGS. 1-2 and 5-6 depict exemplary embodiments of an apparatus for placing colorants onto a surface of a wood-plastic composite. Apparatus 1 may include a printer 10 including a protrusion 11, an applicator 20 configured to apply a colorant 21 to protrusion 11, and a presser 30 configured to press a wood-plastic composite 100 against printer 10 such that protrusion 11 forms a depression 101 on wood-plastic composite 100 and deposits at least some of colorant 21 in depression 101.

As shown in FIG. 1, printer 10 may be in the form of a cylindrical roll, however, printer 10 may have any suitable geometric shape or configuration. For example, printer may be in the shape of a plate. Apparatus 1 may also include more than one printer 10. Printer 10 may be made of any suitable material, for example, one or more metals and/or composites (e.g., flame hardened tool steel with a hardness of about 59 on the Rockwell C-Scale of Hardness (HRC) and having a steel grade of 42 Cr Mo 4).

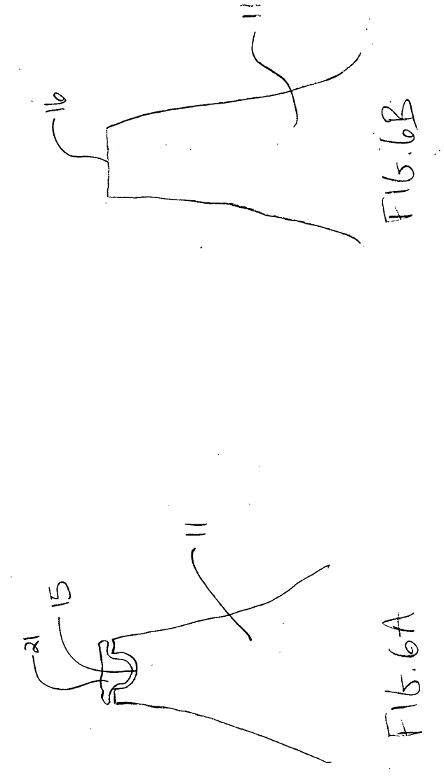

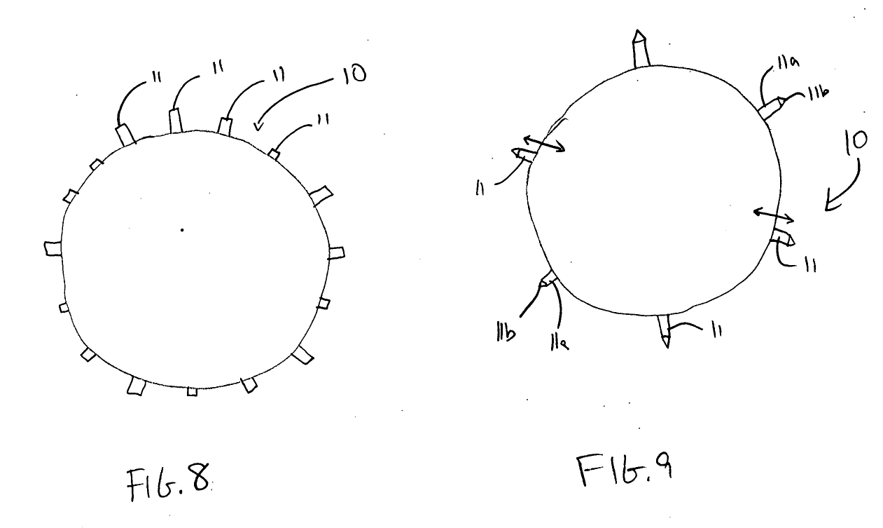

Printer 10 may include at least one protrusion 11 and preferably includes a plurality of protrusions 11. Protrusions 11 may be generally dispersed across an entire surface of printer 10, however, protrusions 11 may also be dispersed across only a portion of printer 10. Protrusions 11 may have any suitable shape and/or configuration, and some of protrusions 11 may have a shape and/or configuration different from other protrusions 11. For example, some of protrusions 11 may have a substantially U-shaped configuration (as shown in FIG. 6), while other protrusions 11 may have a substantially V-shaped configuration (as shown in FIG. 5). As shown in FIG. 9, some protrusions 11 may have a substantially cylindrical base 11a with conical top 11b. In another example, some protrusions 11 may extend further away from printer 10 than other protrusions 11 (i.e., portions of protrusions 11 may have different heights from the surface of printer 10, as shown in FIG. 8). In a further example, some protrusions 11 may have a cross-sectional shape different from that of other protrusions 11. For example, some the protrusions may be substantially cylindrical in shape as shown in FIG. 8. Protrusions 11 may form any suitable pattern. For example, the plurality of protrusions may form text, geometric shapes, patterns and/or repeating configurations. Protrusions 11 may be configured to create depressions 101 on a surface 102 of wood-plastic composite 100 or to force portions of the surface to be slightly raised.

As depicted in FIG. 6A, some of protrusions 11 may have one or more grooves 15. Grooves 15 may be configured to accommodate and retain a colorant 21. Grooves 15 may be on any portion of protrusion 11 and may have any suitable size and shape. Grooves 15 may be configured to allow colorant 21 to be transferred from grooves 15 to depressions 101 on surface 102 of wood-plastic composition 100. Protrusions 11 and/or grooves 15 may be configured (e.g., shaped and/or composed) such that they substantially retain their shape despite being forced into surface 102 of wood-plastic composite 100 to form depressions 102. As depicted in FIG. 6B, however, protrusions 11 need not have defined grooves 15. For example, surface 16 of protrusion 11 may be flat or suitably textured so as to allow surface 16 of protrusions 11 to accommodate and retain colorant 21, and then deposit colorant 21 in depressions 101. Examples of suitable textures for surface 16 include a sand blasted or otherwise machined surface. A flat surface 16 may be suitable to accommodate and retain colorant 21 due to its interaction with colorant 21 (e.g., bonding, surface tension, etc.) Any of the grooves 15 or features of surface 16 may improve colorant pickup, colorant retention, colorant transfer, and/or colorant deposit by protrusion 11.

Protrusions 11 may be made of any suitable material (e.g., one or more metals and/or composites). For example, at least some of protrusions 11 may be made of a material that is strong and/or rigid enough to be forced into wood-plastic composite 100 without substantially and permanently deforming protrusions 11 or printer 10. In another example, different protrusions 11 may be made out of different materials such that different protrusions 11 have different properties (e.g., stiffness, rigidity, and/or strength). In a further example, different portions of one protrusion 11 may be made out of different materials. In still another example, at least a portion of one of protrusions 11 may be configured to suitably deform as protrusion 11 is pressed into wood-plastic composite 100. In a still further example, one or more of protrusions 11 may be made out of the same material as the rest of printer 10.

Protrusions 11 may be dynamically changed on printer 10. For example, as shown in FIG. 9, protrusions 11 may be selectably lowered and/or raised using techniques well known in the art (e.g., hydraulic, pneumatic, electromechanical, servo devices, etc.) such that the configurations and/or patterns of protrusions 11 on printer 10 may be changed as desired. In such a configuration, as printer 10 is rolled across wood-plastic composite 100, by dynamically changing the configuration of protrusions 11 on printer 10, the patterns and/or configurations on wood-plastic composite 100 may be changed across its entire length (e.g., wood-plastic composite 100 may have an irregular pattern even if the length of wood-plastic composite 100 is less than a circumference of printer 10).

Protrusions 11 may be configured to have one or more different colorants 21 placed on it by the applicator 20. An end 12 of protrusion 11 may have colorant 21 disposed on it, however, colorant 21 may be placed on any portion of protrusion 11. For example, colorant 21 may be disposed on end 12 of protrusion 11, may be disposed on a central portion 13 of protrusion 11, and/or may be disposed on the portion 14 of protrusion 11 that connects protrusion 11 to printer 10. In another example, as shown in FIG. 6, colorant 21 may be disposed on any subset of the circumferential portion of protrusion 11 (e.g., when one provides a cross-sectional slice of protrusion 11, colorant 21 may be disposed halfway, or any desired distance, around the outer periphery of the cross-sectional slice).

One or more different colorants 21 may be disposed on protrusions 11 in any suitable combination and/or configuration. For example, as shown in FIG. 6, one or more colorants 21C, 21D may be mixed and placed on any portion of protrusion 11. In another example, first colorant 21C may be placed on a first portion 11C of protrusion 11, and the second colorant 21D may be placed on a second portion 11D of protrusion 11 that may be different from the first portion 11C. In a further example, any portion 11E of protrusion 11 may be free of colorants 21.

One or more protrusions 11 may have one or more different colorants 21 placed on it by the applicator 20 in any desired combination and/or configuration. For example, as shown in FIG. 5, a first protrusion 11A may have a first colorant 21A placed on it, while a second protrusion 11B may have a second colorant 21B placed on it. In another example, the first protrusion 11A may have a colorant 21A placed on it, while the second protrusion 11B may have no colorant 21. In a further example, one or more colorants 21 may be placed on the one or more protrusions 11 such that they form a discernible pattern such as text, pictures, patterns, shapes, and/or any other suitable configuration.

Colorant 21 may be ink and/or pigment of any suitable color. The ink may be water based and/or alcohol based (e.g., toluene, oil, latex, etc.) Colorant 21 may be made up of one or more other colorants 21A, 21B. Colorant 21 may be configured to adhere to surface 102 of wood-plastic composite 100 and/or remain in depressions 101. Colorant 21 may be configured to be disposed within and/or beneath surface 102 of wood-plastic composite 100 on the portions of surface 102 with and/or without depressions 101. Colorant 21 may be configured to be disposed on the one or more protrusions 11 in a manner such that colorant 21 may be suitably transferred from protrusion 11 to wood-plastic composite 100 when protrusion and/or colorant 21 comes into contact with wood-plastic composite 100. Colorant 21 may be configured to resist being removed from surface 102 and/or depressions 101 of wood-plastic composite 100 due to external forces, for example, weather, objects, people, and/or chemicals. Examples of commercially available suitable inks include PENN COLOR™ water based 39C1402 with 5 percent 36B165 black ink and PENN COLOR™ ultraviolet curable 39B1679 outdoor ink.

Presser 30 may have any suitable configuration and/or may be made of any suitable material (e.g., one or more metals and/or composites). For example, presser 30 may be in the shape of a cylinder, a roll, or a plate. As shown in FIG. 1, presser 30 may be disposed in relation to printer 10 such that wood-plastic composite 100 may be placed between presser 30 and printer 10. Presser 30 may be movable relative to printer 10. For example, a gap 40 between presser 30 and printer 10 may be selectably adjusted using any suitable apparatus and/or method of a type well known in the art. Gap 40 may be varied to accommodate wood-plastic composite 100 of various size and/or shape. Gap 40 may be dynamically adjusted, for example, while wood-plastic composite 100 is being advanced through the gap 40 and/or between presser 30 and printer 10. Further presser 30 may be replaced by a second printer 10 on a second printing station with presser 30 and printer 10 disposed opposite the configuration shown in FIG. 1 to print or color both sides of composite 100.

Presser 30 may be configured to press wood-plastic composite 100 against printer 10 and/or protrusions 11 such that protrusions 11 break the plane of surface 102 of wood-plastic composite 100 and form depressions 101. Presser 30 and printer 10 may be disposed relative to each other such that protrusions 11 enter into wood-plastic composite 100 the desired amount and/or depth. Presser 30 and printer 10 may be configured to apply one or more colorants 21 in at least a portion of the one or more depressions 101, over at least a portion of surface 102 of the portion of wood-plastic composite 100.

Apparatus 1 may include a feeder configured to feed wood-plastic composite 100 between printer 10 and presser 30.

Exemplary embodiments of the invention may include a wood-plastic composite. Wood-plastic composite 100 may have any suitable composition. For example, wood-plastic composite 100 may include plastic such as polypropylene and/or polyethylene. In another example, wood-plastic composite 100 may include a plurality of wood fibers of any size and/or configuration which may include one or more hardwoods and/or one or more softwoods. The plurality of wood fibers may be intermixed with plastic. In a further example, wood-plastic composite 100 may have a composition disclosed in, manufactured using the apparatus disclosed in, and/or manufactured from the method disclosed in co-pending and co-owned U.S. patent application Ser. No. 10/668,368 filed Sep. 24, 2003, the entirety of which is incorporated herein by reference. Other examples of wood-plastic composites, methods of manufacturing wood-plastic composites, and apparatus for manufacturing wood-plastic composites are disclosed in co-owned U.S. Pat. Nos. 5,851,469 and 6,527,532, and co-pending and co-owned U.S. patent application Ser. No. 10/292,672 filed Nov. 12, 2002, the entirety of each of which are incorporated herein by reference. In various embodiments, composite 100 may not be wood-plastic, and instead may be composed of any suitable composition (e.g., all plastic, have different fillers, and/or be made of other composite materials).

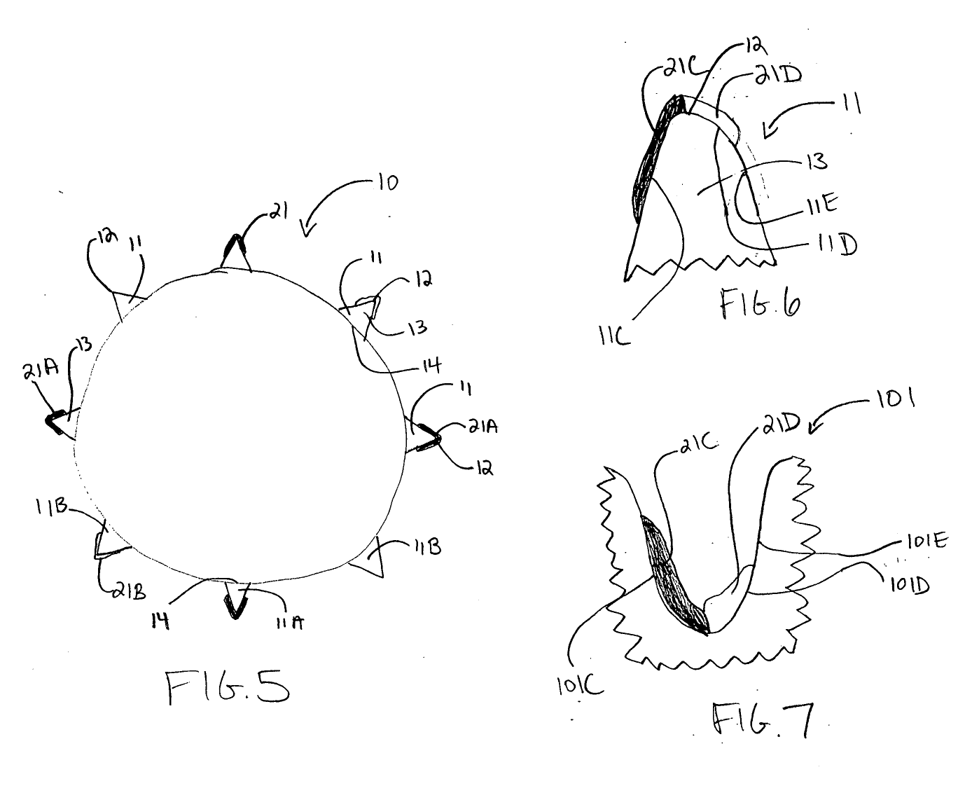

As shown in FIGS. 1, 3-4, and 7, wood-plastic composite 100 may have one or more surfaces 102 on or in which one or more of depressions 101 may be disposed. Depressions 101 may be disposed on any surface 102 and/or portion of wood-plastic composite 100. Depressions 101 may form any suitable shape, pattern, combination, and/or configuration. For example, as shown in. FIG. 4, depressions 101 on at least a portion of wood-plastic composite 100 may be disposed substantially adjacent to each other such that they form a substantially undulating and/or wavy surface with peaks 103. In another example, depressions 101 may have a configuration substantially similar to the interior configuration of an egg carton. In a further example, depressions 101 may form text and/or geometric shapes.

Wood-plastic composite 100 may accept one or more colorants 21 on any portion of any surface of wood-plastic composite 100. For example, one or more of depressions 101 may have one or more colorants 21 disposed in them. In another example, one or more of colorants 21 may be disposed in the portion of wood-plastic composite 100 that defines the one or more depressions 101.

In a further example, depressions 101 and/or colorants 21 may be configured such that wood-plastic composite 100 appears to have a color different from the base color of wood-plastic composite 100 (e.g., wood-plastic composite 100 may have a substantially gray base color, however, by spacing depressions 101 relatively close together and/or by placing a blue colorant 21 in depressions 101, wood-plastic composite 100 may appear to have a substantially blue color).

In still another example, a first set of depressions 101A may have a first colorant 21A and a second set of depressions 101B different from the first set of depressions 101A may have a second colorant 21B different from the first colorant 21A. Thus, in a first configuration, wood-plastic composite 100 may appear to have a base color of the first colorant 21A with a pattern (e.g., text and/or geometric shapes) having the second colorant 21B, while in a second configuration, wood plastic composite 100 may appear to have a color that is a combination of the two colorants 21A, 21B (e.g., colorants 21A, 21B may be yellow and red, respectively, and thus wood-plastic composite may appear orange). The second configuration may substantially be accomplished by alternating colorants 21A, 21B across adjacent depressions 101A, 101B and/or adjacent sets of depressions 101A, 101B.

In a still further example, a first set of depressions 101A may have one or more colorants 21 while a second set of depressions 101B different from the first set of depressions 101A may not have any colorant 21. In a first configuration, a first portion of wood-plastic composite 100 with first set of depressions 101A may appear to have the color of a colorant 21 that is different from the base color of wood-plastic composite 100, and a second portion of wood-plastic composite 100 with second set of depressions 101B may appear to have the base color of wood-plastic composite 100. In such a configuration, the first portion may form a pattern (e.g., text and/or geometric shapes) while the second portion may form the background. In a second configuration, depressions 101A with the one or more colorants 21 may be substantially evenly dispersed across wood-plastic composite 100 such that wood-plastic composite appears to have a color that is a mixture of the one or more colorants 21 and the base color of wood-plastic composite 100.

In yet another example, as shown in FIG. 7, a first portion 101C of depression 101 may have a first colorant 21C while a second portion 101D of depression 101 different from first portion 101C may have a second colorant 21D different from first colorant 21C. Colorants 21A, 21B may, from a distance, appear to have a color that is a combination of colorants 21A, 21B.

In a yet further example, as shown in FIG. 7, a first portion 101C of depression 101 may have a colorant 21C while a second portion 101E of depression 101 different from first portion 101C may not have any colorant 21. Depressions 101 having such one or more colorants 21A, 21B may appear to have a color that is a combination of the one or more colorants 21A, 21B and the base color of wood-plastic composite 100.

Colorant 21 may be any suitable ink and/or pigment having one or more of the features of any of colorants 21 set forth herein.

Wood-plastic composite 100 may have any suitable shape and/or configuration. For example, wood-plastic composite 100 may be any suitable building component. In another example, wood-plastic composite 100 may be a decking board, railing, indoor flooring, trim, and/or any other decking component. In a further example, wood-plastic composite 100 may be configured to placed through any suitable printer 10 and presser 30 combination.

Embodiments of the invention includes a method of placing colorants on a wood-plastic composite. The method may includes providing a wood-plastic composite 100 having a surface 102, creating a plurality of depressions 101 on surface 102 of wood-plastic composite 100, and/or depositing a colorant 21 in one or more of the plurality of depressions 101.

Providing wood-plastic composite 100 may include providing any of wood-plastic composites 100 set forth herein. For example, wood-plastic composite 100 may be one or more of a building component, a decking components, a decking board, and/or a railing.

Wood-plastic composite 100 may be fed using a feeder between printer 10 and presser 30. Printer 10 may be heated (e.g., to approximately 135 degrees Fahrenheit) to improve the applicability of colorant 21 on at least one of protrusions 11 and depressions 101, depending on the properties of colorant 21. However, printer 10 need not be heated and may instead be cooled in certain situations (e.g., depending on the composition of colorant 21 and/or wood-plastic composite 100). Protrusions 11 on printer 10 may be pressed via presser 30 into surface 102 of wood-plastic composite 100 to form depressions 101. In particular, presser 30 may press wood-plastic composite 100 into end 12 of protrusions 11 of printer 10 to form depressions 101. Depressions 101 may be disposed within wood-plastic composite 100 and/or below surface 102 of wood-plastic composite 100.

Presser 30 and printer 10 may roll in substantially opposite directions relative to each other as wood-plastic composite 100 is fed between them. If a circumference printer 10 is less than a length of wood-plastic composite 100, the static pattern on printer 10 may be disposed multiple times on wood-plastic composite 100. If the pattern and/or configuration of protrusions 11 on printer 10 are suitably, selectably, and/or dynamically altered, any suitable regular or irregular pattern may be placed across the entire length of wood-plastic composite 100 regardless of the circumference of printer 10.

One or more applicators 20 may deposit one or more colorants 21 on protrusions 11. Applicator 20 may itself deposit one or more colorants 21, or one applicator 20 may deposit one colorant 21 while another applicator 20 deposits another colorant 21. Applicator 20 may apply one or more colorants 21 to protrusions 11 before, during, and/or after protrusions 11 create depressions 101 on wood-plastic composite 100. Applicator 20 may be any suitable applicator known in the art, for example, an ink jet, a transfer roller, a brush, and\or a spray. For example, applicator 20 may be a rubber roll having a durometer of about 30. Colorant 21 may be applied to the rubber roll by an anilox roll, or by coating the rubber roll in a bath and then wiping some of excess colorant off the rubber roll off with another device (e.g., brush or braid). The rubber roll may include one or more separators, each of which divide the rubber roll such that one colorant 21 may be disposed on one portion of the roll, while another colorant 21 is disposed on another portion of the roll.

Applicator 20 may apply a first colorant 21A to a first set of protrusions 11A and a second colorant 21B different from the first colorant 21A to a second set of protrusions 11B different from the first set of protrusions 11A. For example, applicator 20 may be a plurality of rubber rolls, each roll having a different colorant 21A, 21B disposed on it. The rubber rolls may be configured such that they only apply colorant to certain protrusions 11A, 11B, for example, by being raised at portions where it is desirable for the roll to contact protrusions 11A and deposit colorant 21A, and being depressed at portion where it is not desirable for the roll to contact protrusions 11B and deposit colorant 21A. In another example, applicator 20 may be a plurality of rubber rolls, each roll having a different colorant 21A, 21B disposed on it. Instead of having raised and depressed portions, however, protrusions 11A may be moved up and down relative to the rest of the printer 10 such that when the first set of protrusions 11A are raised, a first applicator 20 having a first colorant 21A may apply the first colorant 21A only to the first set of protrusions 11A. The first set of protrusions 11A may then be lowered, and a second set of protrusions 11B different from the first set of protrusions 11A may then be raised. A second applicator 20 having a second colorant 21B different from the first colorant 21A may then apply the second colorant 21B only to the second set of protrusions 11B. Applicator 20 may apply a colorant 21 to a first set of protrusions 11A and not deposit any colorant 21 to a second set of protrusions 11B different from the first set of protrusions 11A. Applicator 20 may apply a first colorant 21C to a first portion 11C of protrusion 11 and a second colorant 21D different from the first colorant 21C to a second portion 11D of protrusion 11 different from the first portion 11C of protrusion 11. Applicator 20 may apply a colorant 21C to a first portion 11C of protrusion 11 and not apply any colorant 21 to a second portion 11E of protrusion 11 different from the first portion 11C of protrusion 11. Applicator 20 may apply colorant 21 to any of grooves 15 and/or any portion of surface 16.

Once one or more colorants 21 have been applied to protrusions 11, protrusions 11 may apply colorant 21 to one or more depressions 101 before, during, and/or after protrusions 11 form depressions 101 on wood-plastic composite 100. First set of protrusions 11A may apply first colorant 21A to first set of depressions 101A, and second set of protrusions 11B different from first set of protrusions 11A may apply second colorant 21B different from the first colorant 21A to second set of depressions 101B different from first set of depressions 101A. First set of protrusions 11A may apply colorant 21 to first set of depressions 101A and not apply any colorant 21 to second set of protrusions 11B different from first set of protrusions 11A. Protrusion 11 may apply first colorant 21C to first portion 101C of depression 101 and second colorant 21D different from first colorant 21C to second portion 101D of depression 101 different from first portion 101C of protrusion 11A. Protrusion 11 may apply colorant 21C to first portion 101C of depression 101 and not apply any colorant 21 to second portion 101E of depression 101 different from first portion 101C of depression 101.

Once depressions 101 have been formed and one or more colorants 21 have been applied to depressions 101, colorants 21 may be set within depressions 101 and/or within the portion of surface 102 that defines depressions 101 using any suitable means (e.g., drying, laminating, curing) such that one or more colorants 21 cannot be easily removed from depressions 101.

In various embodiments, the apparatus may include various combinations of the aspects set forth herein. For example, the apparatus may include more than one printer. The first printer may include protrusions to form the depressions, and the second printer, with or without protrusions, may apply the colorant into the depressions. In another example, the apparatus may be configured such that the applicator applies colorant directly into the depressions. Thus, the applicator may not apply the apply the colorant to the protrusions on the printer.

One advantage of wood-plastic composite 100 produced by using this method is that because colorant 21 is disposed in depressions 101 and/or lower than surface 102 of wood-plastic composite 100, external forces cannot as easily affect colorant 21. Portions of wood-plastic composite 100 higher than colorant 21 (e.g., peaks 103) may come into contact with the external forces first and may substantially prevent the external forces from affecting colorant 21. This will assist wood-plastic composite 100 in retaining any colorant 21 and thus allow wood-plastic composite 100 to be any desired color, and not just a color dictated by the materials used and/or the process of manufacturing wood-plastic composite 100 itself.

Another advantage is that because colorant 21 may be more precisely and selectably applied to wood-plastic composite 100 using applicator 20 and protrusions 11, recognizable color patterns may be placed onto surface 102 of wood-plastic composite 100. For example, text, such as a company's name and/or trademark, may be applied to surface 102. In another example, shapes, such as a company's logo, may be applied to surface 102.

One of ordinary skill in the art will recognize that some aspects of the invention may be used alone or in combination with other aspects to form additional embodiments of the invention. For example, applicator 20 may include two or more applicators, and each applicator may apply a different colorant 21 to protrusions 11.

Protrusions 11 have different heights may have a different colorant 21 applied to them based on the height of the respective protrusion 11.

One of ordinary skill in the art will also recognize that some of the aspects set forth herein may be removed to form different embodiments of the invention. For example, colorant 21 need not be applied to any suitable portion of wood-plastic composite 101.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus, comprising:
a printer including one or more protrusions;
an applicator configured to apply a colorant to one or more of the one or more protrusions; and
a presser configured to press wood-plastic composite against the printer such that the one or more protrusions form one or more depressions in the wood-plastic composite and deposits the colorant in at least one of the one or more depressions.

2. The apparatus of claim 1, wherein the printer is at least one of a cylinder, a roll, and a plate.

3. The apparatus of claim 1, wherein the one or more protrusions form a pattern.

4. The apparatus of claim 1, wherein the applicator is configured to apply the colorant to a first of the one or more protrusions and apply another colorant different from the colorant to a second of the one or more protrusions.

5. The apparatus of claim 1, wherein the applicator is configured to apply the colorant to a first of the one or more protrusions and not apply the colorant to a second of the one or more protrusions.

6. The apparatus of claim 1, wherein the colorant comprises a plurality of colorants.

7. The apparatus of claim 1, wherein the presser is at least one of a cylinder, a roll, and a plate.

8. The apparatus of claim 1, wherein the printer and the presser define a gap configured to accommodate the wood-plastic composite.

9. The apparatus of claim 1, wherein the wood-plastic composite further comprises a surface and the colorant is applied to the wood-plastic composite below the surface.

10. The apparatus of claim 1, wherein the wood-plastic composite further comprises a surface and the colorant is applied to the wood-plastic composite below the surface.

11. The apparatus of claim 1, wherein the presser and the printer are configured to form the one or more depressions on the wood-plastic composite and deposit at least some of the colorant in the one or more depressions substantially simultaneously.

12. The apparatus of claim 1, wherein the protrusions include at least one a groove and a textured surface.

13. A composite, comprising:
a plastic;
a plurality wood fibers intermixed with the plastic;
a surface comprising a plurality of depressions formed therein; and
a colorant disposed in one or more of the plurality of depressions.

14. The composite of claim 13, wherein the plastic is at least one of polypropylene and polyethylene and the wood fiber is at least one of a hardwood and a softwood.

15. The composite of claim 13, wherein the colorant is disposed below the surface.

16. The composite of claim 13, wherein the plurality of depressions are disposed below the surface.

17. The composite of claim 13, further comprising another colorant different from the colorant,
wherein the colorant is disposed in one or more of the plurality of depressions and the another colorant is disposed in one or more of the plurality of depressions.

18. The composite of claim 13, wherein the colorant is disposed in a first portion of one of the plurality of depressions and not disposed in a second portion of the one of the plurality of depressions different from the first portion.

19. The composite of claim 13, wherein the colorant is a plurality of colorants.

20. The composite of claim 13, wherein the composite is at least one of a board, a decking board, and a decking component.

21. The composite of claim 13, wherein the colorant is disposed in at least a portion of the surface defining the plurality of depressions.

22. The composite of claim 13, wherein the composite is configured to impede removal of the colorant from the plurality of depressions.

23. The composite of claim 13, wherein the surface appears to be a same color as the colorant.

24. The composite of claim 13, wherein the surface appears to be a color different from a base color of the composite.

25. A method comprising:
providing a wood-plastic composite having a surface;
creating a plurality of depressions on surface of wood-plastic composite; and
depositing a colorant in the plurality of depressions.

26. The method of claim 25, wherein providing the wood-plastic composite includes providing at least one of a wood-plastic board, a wood-plastic decking board, and a wood-plastic decking component.

27. The method of claim 25, wherein creating the plurality of depressions includes creating the plurality of depressions using a plurality of protrusions.

28. The method of claim 25, wherein creating the plurality of depressions includes creating the plurality of depressions such that the plurality of depressions are disposed below the surface.

29. The method of claim 25, wherein depositing the colorant includes depositing the colorant in a first subset of the plurality of depressions,
the method further comprising depositing another colorant in a second subset of the plurality of depressions different from the first subset.

30. The method of claim 25, wherein depositing the colorant includes depositing the colorant in a first subset of the plurality of depressions and not depositing the colorant in a second subset of the plurality of depressions different from the subset of the plurality of depressions.

31. The method of claim 25, further comprising depositing the colorant in at least a portion of the surface defining the plurality of depressions.

32. The method of claim 25, further comprising feeding the wood-plastic composite between a plurality of cylinders,
wherein one of the plurality of cylinders is configured to create the plurality of depressions.

33. The method of claim 27, wherein the plurality of protrusions have at least one of a groove and a textured surface.
